(19) United States
(12) Patent Application Publication
(10) Pub. No.: US 2024/0260069 A1
(43) Pub. Date: Aug. 1, 2024

(54) CHANNEL STATE INFORMATION PREDICTION WITH BEAM UPDATE

(71) Applicant: QUALCOMM Incorporated, San Diego, CA (US)

(72) Inventors: Tianyang BAI, Somerville, NJ (US); Kiran VENUGOPAL, Green Brook, NJ (US); Junyi LI, Fairless Hills, PA (US)

(21) Appl. No.: 18/162,485

(22) Filed: Jan. 31, 2023

(51) Int. Cl. H04W 72/54; H04W 72/044

(52) U.S. Cl. CPC H04W 72/54; H04W 72/046

(57) ABSTRACT

Certain aspects of the present disclosure provide a method of wireless communication at a user equipment (UE), generally including outputting, for transmission, a first channel prediction report based on measurements of first reference signals (RS) associated with a first beam; outputting, for transmission, a beam prediction report indicating a second beam; outputting, for transmission before a predicted application time for the second beam, a second channel prediction report based on measurements of second RS associated with the second beam, said second channel prediction report indicating a precoder; and obtaining a beamformed transmission based on the second beam and the precoder.

### BACKGROUND

### Field of the Disclosure

Aspects of the present disclosure relate to wireless communications, and more particularly, to techniques for coordinating channel state information (CSI) prediction with a beam update.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication at a user equipment (UE). The method includes outputting, for transmission, a first channel prediction report based on measurements of first reference signals (RS) associated with a first beam; outputting, for transmission, a beam prediction report indicating a second beam; outputting, for transmission before a predicted application time for the second beam, a second channel prediction report based on measurements of second RS associated with the second beam, said second channel prediction report indicating a precoder; and obtaining a beamformed transmission based on the second beam and the precoder.

Another aspect provides a method of wireless communication at a network entity. The method includes obtaining a first channel prediction report based on measurements of first channel prediction RS associated with a first beam; obtaining a beam prediction report indicating a second beam; obtaining, before a predicted application time for the second beam, a second channel prediction report based on measurements of second channel prediction RS associated with the second beam, said second channel prediction report indicating a precoder; and outputting, for transmission, a beamformed transmission based on the second beam and the precoder.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example machine learning (ML) functional framework for RAN intelligence.

FIG. 6 is a diagram illustrating example operations where beam management may be performed.

FIG. 7 depicts an example ML model structure and parameter set.

FIG. 8 depicts an example beam predictor.

FIG. 9 depicts an example ML model for beam prediction.

FIGS. 10A and 10B depict example deployments of a prediction module.

FIG. 11 depicts an example timeline for channel state information (CSI) prediction.

FIG. 12 depicts an example timeline for CSI prediction with a beam update.

FIG. 13 depicts an example timeline for CSI prediction and beam prediction.

FIG. 14 depicts one example timeline for CSI prediction coordinated with a beam update, in accordance with aspects of the present disclosure.

FIG. 15 depicts another example timeline for CSI prediction coordinated with a beam update, in accordance with aspects of the present disclosure.

FIG. 16 depicts a method for wireless communications.

FIG. 17 depicts a method for wireless communications.

FIG. 18 depicts aspects of an example communications device.

### DETAILED DESCRIPTION

Aspects of the present disclosure provide apparatuses, methods, processing systems, and computer-readable mediums for coordinating channel state information (CSI) prediction with a beam update.

There are a variety of different use cases for Artificial intelligence (AI) and machine learning (ML) based models (hereinafter, simply ML-based models or ML models) in wireless networks. For example, ML-based models may be used to enhance channel state information (CSI) feedback. In such cases, ML models may help reduce overhead and improve accuracy based on predictions. For example, ML-based CSI prediction generally focuses on predicting the channel (channel state information) for a future time, given a fixed beamformed direction (beam). ML models may also be used to enhance beam management, for example, using beam prediction in the time domain, and/or spatial domain for overhead and latency reduction and beam selection accuracy improvement. ML-based models may also be used to enhance positioning accuracy for different scenarios.

Reference signals (RS) intended for different purposes may be sent in different ways. For example, RS for beam prediction may be sent using different beams and relatively narrowband (NB) on relatively few resource elements (REs). On the other hand, RS for channel prediction may be sent using the same beam and a wide band (WB) on more REs (than used for beam prediction).

In some cases, timing of applying a beam update (based on beam prediction) may create challenges with regard to channel prediction. For example, channel prediction may be based on RS transmitted with a first beam that is no longer valid after a beam update. This may result in a time period where the new beam is used for a transmissions, such as a physical downlink shared channel (PDSCH), before there is a channel prediction (precoder) available for the new beam.

Aspects of the present disclosure provide techniques that may help coordinate channel prediction and beam prediction. For example, the techniques proposed herein may allow channel prediction RS to be sent with a new beam before a predicted application time for using this new beam. This approach may allow channel prediction to be performed for the new beam sooner. This may allow a more suitable precoder to be reported sooner, which may then be applied to a transmission using the new beam, thereby improving overall system performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

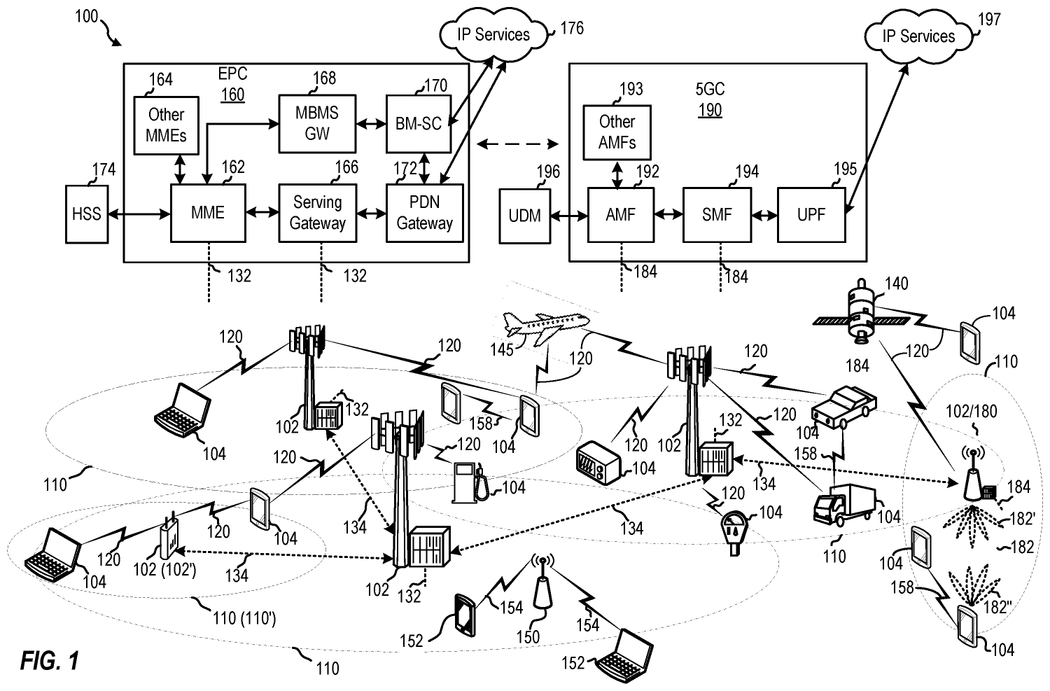

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

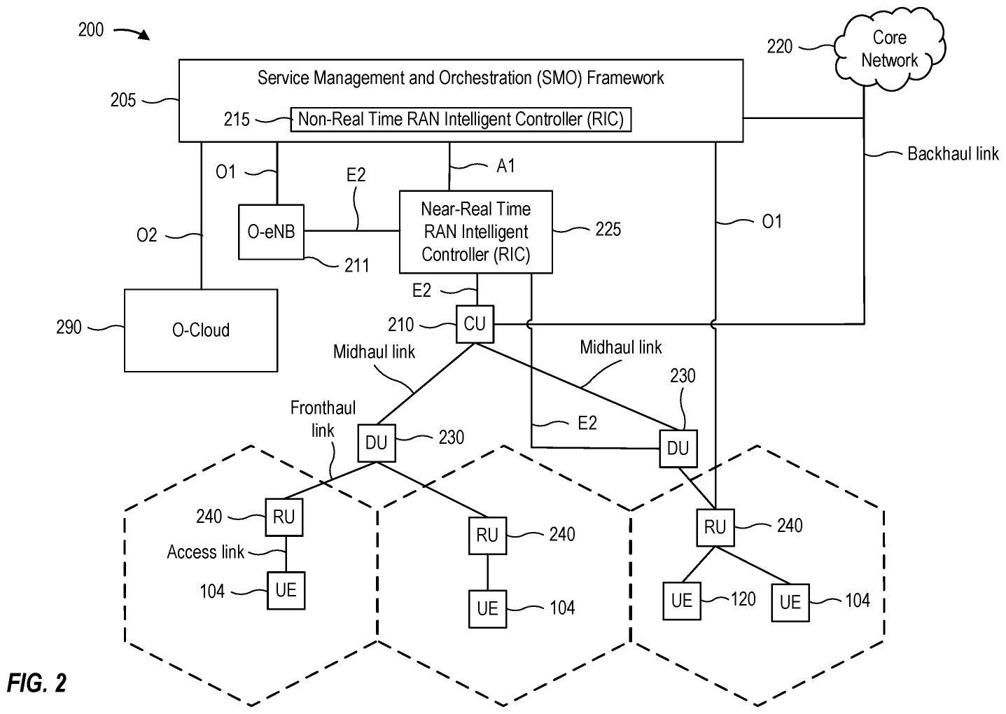

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

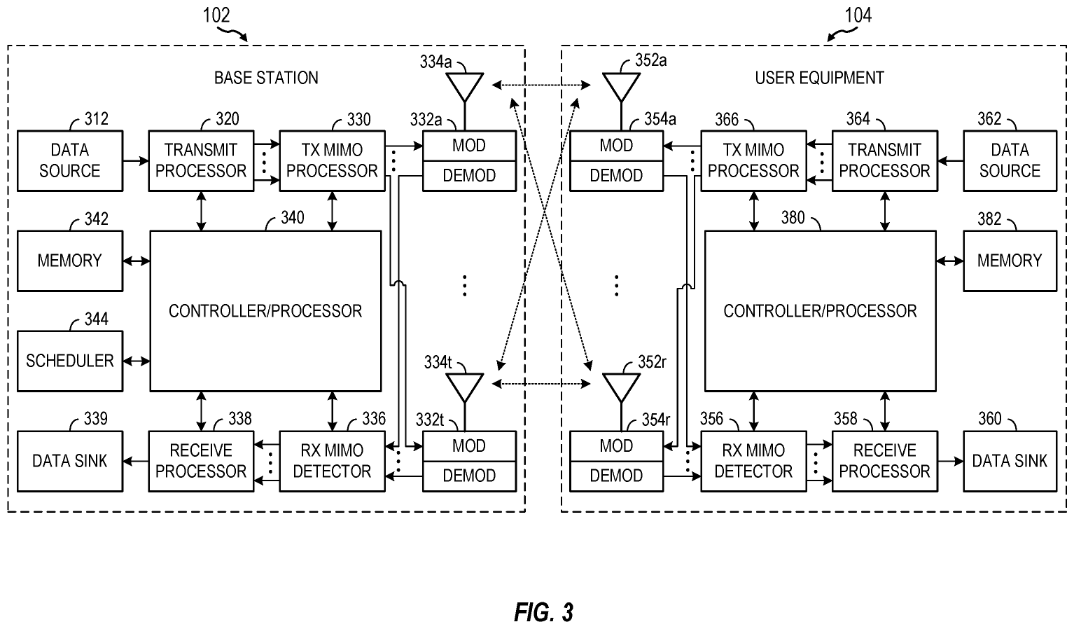

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

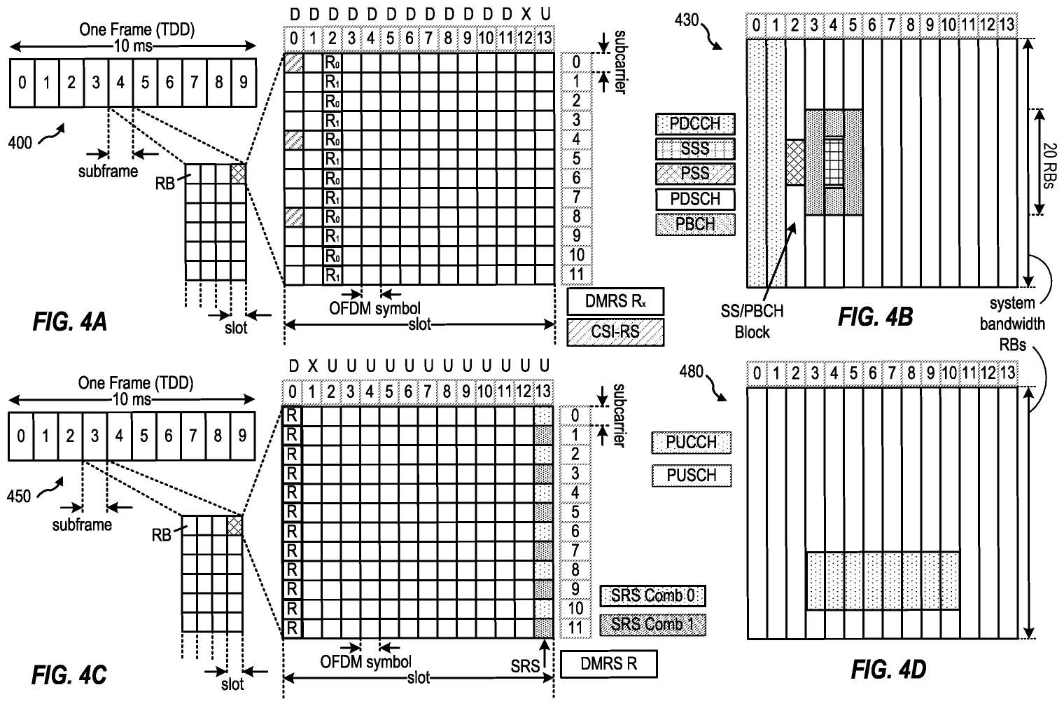

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### QCL Port and TCI States

In many cases, it is important for a UE to know which assumptions it can make on a channel corresponding to different transmissions. For example, the UE may need to know which reference signals it can use to estimate the channel in order to decode a transmitted signal (e.g., PDCCH or PDSCH). It may also be important for the UE to be able to report relevant channel state information (CSI) to the BS (gNB) for scheduling, link adaptation, and/or beam management purposes. In NR, the concept of quasi co-location (QCL) and transmission configuration indicator (TCI) states is used to convey information about these assumptions.

QCL assumptions are generally defined in terms of channel properties. Per 3GPP TS 38.214, “two antenna ports are said to be quasi-co-located if properties of the channel over which a symbol on one antenna port is conveyed can be inferred from the channel over which a symbol on the other antenna port is conveyed.” Different reference signals may be considered quasi co-located (“QCL'd”) if a receiver (e.g., a UE) can apply channel properties determined by detecting a first reference signal to help detect a second reference signal. TCI states generally include configurations such as QCL-relationships, for example, between the DL RSs in one CSI-RS set and the PDSCH DMRS ports.

In some cases, a UE may be configured with up to M TCI-States. Configuration of the M TCI-States can come about via higher layer signalling, while a UE may be signalled to decode PDSCH according to a detected PDCCH with DCI indicating one of the TCI states. Each configured TCI state may include one RS set TCI-RS-SetConfig that indicates different QCL assumptions between certain source and target signals.

For example, TCI-RS-SetConfig may indicate a source reference signal (RS) is indicated in the top block and is associated with a target signal indicated in the bottom block. In this context, a target signal generally refers to a signal for which channel properties may be inferred by measuring those channel properties for an associated source signal. As noted above, a UE may use the source RS to determine various channel parameters, depending on the associated QCL type, and use those various channel properties (determined based on the source RS) to process the target signal. A target RS does not necessarily need to be PDSCH's DMRS, rather it can be any other RS: PUSCH DMRS, CSIRS, TRS, and SRS.

Each TCI-RS-SetConfig may contain various parameters. These parameters can, for example, configure quasi co-location relationship(s) between reference signals in the RS set and the DM-RS port group of the PDSCH. The RS set contains a reference to either one or two DL RSs and an associated quasi co-location type (QCL-Type) for each one configured by the higher layer parameter QCL-Type.

For the case of two DL RSs, the QCL types can take on a variety of arrangements. For example, QCL types may not be the same, regardless of whether the references are to the same DL RS or different DL RSs. In the illustrated example, SSB is associated with Type C QCL for P-TRS, while CSI-RS for beam management (CSIRS-BM) is associated with Type D QCL.

QCL information and/or types may in some scenarios depend on or be a function of other information. For example, the quasi co-location (QCL) types indicated to the UE can be based on higher layer parameter QCL-Type and may take one or a combination of the following types:
QCL-TypeA: {Doppler shift, Doppler spread, average delay, delay spread},
QCL-TypeB: {Doppler shift, Doppler spread},
QCL-TypeC: {average delay, Doppler shift}, and
QCL-TypeD: {Spatial Rx parameter},
   Spatial QCL assumptions (QCL-TypeD) may be used to help a UE to select an analog Rx beam (e.g., during beam management procedures). For example, an SSB resource indicator may indicate a same beam for a previous reference signal should be used for a subsequent transmission.

An initial CORESET (e.g., CORESET ID 0 or simply CORESET #0) in NR may be identified during initial access by a UE (e.g., via a field in the MIB). A ControlResourceSet information element (CORESET IE) sent via radio resource control (RRC) signaling may convey information regarding a CORESET configured for a UE. The CORESET IE generally includes a CORESET ID, an indication of frequency domain resources (e.g., number of RBs) assigned to the CORESET, contiguous time duration of the CORESET in a number of symbols, and Transmission Configuration Indicator (TCI) states.

As noted above, a subset of the TCI states provide quasi co-location (QCL) relationships between DL RS(s) in one RS set (e.g., TCI-Set) and PDCCH demodulation RS (DMRS) ports. A particular TCI state for a given UE (e.g., for unicast PDCCH) may be conveyed to the UE by the Medium Access Control (MAC) Control Element (MAC-CE). The particular TCI state is generally selected from the set of TCI states conveyed by the CORESET IE, with the initial CORESET (CORESET #0) generally configured via MIB.

Search space information may also be provided via RRC signaling. For example, the SearchSpace IE is another RRC IE that defines how and where to search for PDCCH candidates for a given CORESET. Each search space is associated with one CORESET. The SearchSpace IE identifies a search space configured for a CORESET by a search space ID. In an aspect, the search space ID associated with CORESET #0 is SearchSpace ID #0. The search space is generally configured via PBCH (MIB).

### Example Framework for AI/ML in a Radio Access Network

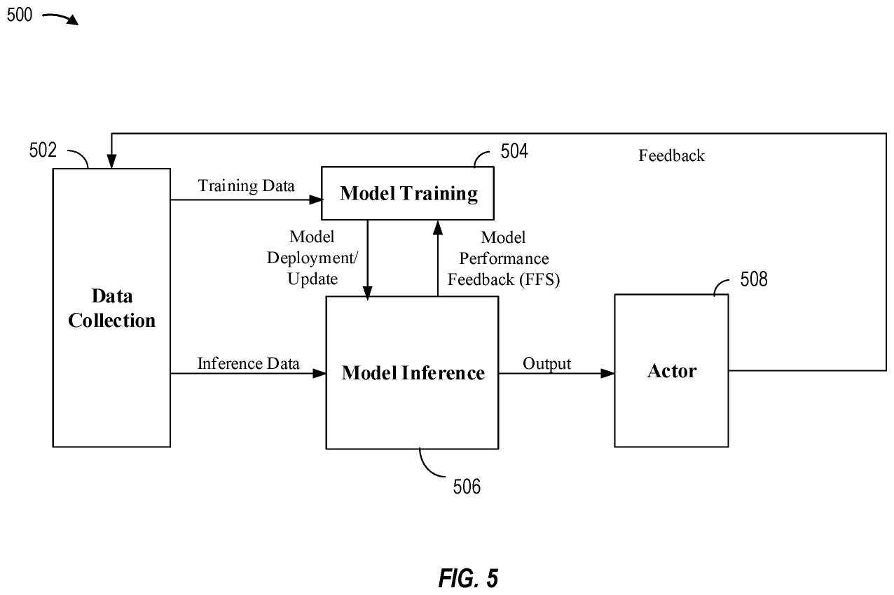

FIG. 5 depicts an example of AI/ML functional framework 500 for RAN intelligence, in which aspects described herein may be implemented.

The AI/ML functional framework includes a data collection function 502, a model training function 504, a model inference function 506, and an actor function 508, which interoperate to provide a platform for collaboratively applying AI/ML to various procedures in RAN.

The data collection function 502 generally provides input data to the model training function 504 and the model inference function 506. AI/ML algorithm specific data preparation (e.g., data pre-processing and cleaning, formatting, and transformation) may not be carried out in the data collection function 502.

Examples of input data to the data collection function 502 (or other functions) may include measurements from UEs or different network entities, feedback from the actor function, and output from an AI/ML model. In some cases, analysis of data needed at the model training function 504 and the model inference function 506 may be performed at the data collection function 502. As illustrated, the data collection function 502 may deliver training data to the model training function 504 and inference data to the model inference function 506.

The model training function 504 may perform AI/ML model training, validation, and testing, which may generate model performance metrics as part of the model testing procedure. The model training function 504 may also be responsible for data preparation (e.g., data pre-processing and cleaning, formatting, and transformation) based on the training data delivered by the data collection function 502, if required.

The model training function 504 may provide model deployment/update data to the Model interface function 506. The model deployment/update data may be used to initially deploy a trained, validated, and tested AI/ML model to the model inference function 506 or to deliver an updated model to the model inference function 506.

As illustrated, the model inference function 506 may provide AI/ML model inference output (e.g., predictions or decisions) to the actor function 508 and may also provide model performance feedback to the model training function 504, at times. The model inference function 506 may also be responsible for data preparation (e.g., data pre-processing and cleaning, formatting, and transformation) based on inference data delivered by the data collection function 502, at times.

The inference output of the AI/ML model may be produced by the model inference function 506. Specific details of this output may be specific in terms of use cases. The model performance feedback may be used for monitoring the performance of the AI/ML model, at times. In some cases, the model performance feedback may be delivered to the model training function 504, for example, if certain information derived from the model inference function is suitable for improvement of the AI/ML model trained in the model training function 504.

The model inference function 506 may signal the outputs of the model to nodes that have requested them (e.g., via subscription), or nodes that take actions based on the output from the model inference function. An AI/ML model used in a model inference function 506 may need to be initially trained, validated and tested by a model training function before deployment. The model training function 504 and model inference function 506 may be able to request specific information to be used to train or execute the AI/ML algorithm and to avoid reception of unnecessary information. The nature of such information may depend on the use case and on the AI/ML algorithm.

The actor function 508 may receive the output from the model inference function 506, which may trigger or perform corresponding actions. The actor function 508 may trigger actions directed to other entities or to itself. The feedback generated by the actor function 508 may provide information used to derive training data, inference data or to monitor the performance of the AI/ML Model. As noted above, input data for a data collection function 502 may include this feedback from the actor function 508. The feedback from the actor function 508 or other network entities (via Data Collection function) may also be used at the model inference function 506.

The AI/ML functional framework 500 may be deployed in various RAN intelligence-based use cases. Such use cases may include CSI feedback enhancement, enhanced beam management (BM), positioning and location (Pos-Loc) accuracy enhancement, and various other use cases.

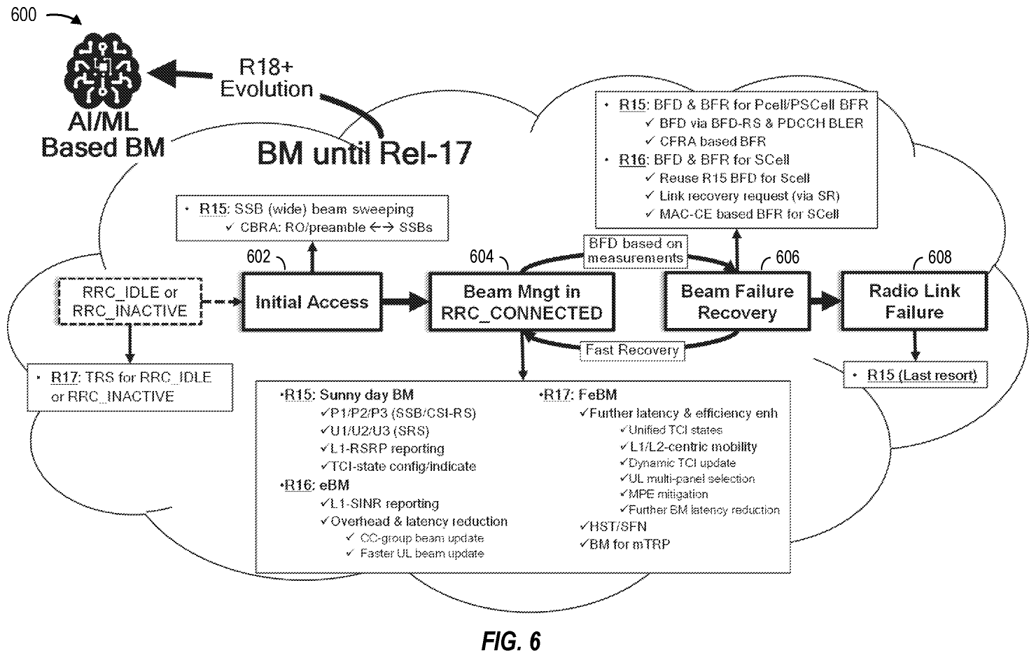

FIG. 6 is a diagram illustrating example operations where AI/ML based beam management may be performed. In initial access 602, the network may sweep through several beams, for example, via synchronization signal blocks (SSBs), as further described herein with respect to FIG. 4B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS). A UE may use SSB detection to identify a RACH occasion (RO) for sending a RACH preamble (e.g., as part of a contention CBRA procedure).

In connected mode 604, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 606, which may allow a UE to return to connected mode 604 without performing a radio link failure procedure 608. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 608 to recover from the radio link failure, such as a RACH procedure.

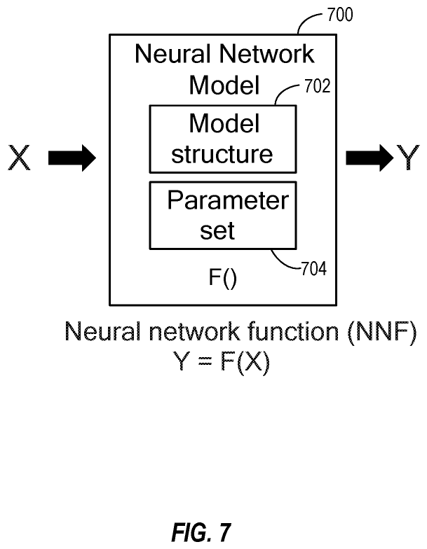

As illustrated in FIG. 7, in some cases, an ML model may be implemented as a neural network (NN) model 700 that supports at least one NN Function (NNF): Y=F(X). In some cases, each NNF may be identified by a standardized NNF ID, though non-standardized IDs may also be allowed (e.g., for private extensions). There may be standardized input X and output Y for each NNF, with mandatory information elements (IEs) for inter-vendor interworking and optional IEs for flexible implementation. One NNF may be supported by multiple NN models (e.g., for vendor specific implementations).

The NN model 700 may be defined as a model structure 702 and a parameter set 704. The model structure may be identified by a model ID (e.g., that includes a default parameter set). Each model ID may be unique in a network and may be associated with an NNF. The parameter set may include weights of the NN model and other configuration parameters. A parameter set may be location specific and/or configuration specific.

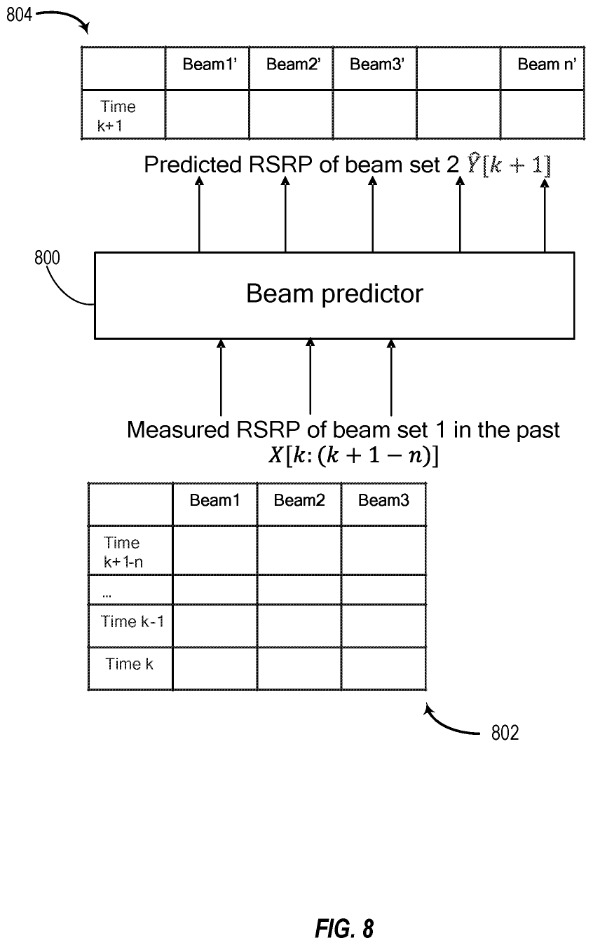

FIG. 8 illustrates an example beam predictor 800 configured to perform beam prediction. For beam prediction, an algorithm may be trained to predict future reference signal received power (RSRP) of one beam set (e.g., beam set 2 804), based on past measurement of a first beam set (e.g., beam set 1 802).

Any suitable algorithm may be used, such as a recursive NN or traditional algorithm. The algorithm can be trained and maintained by a gNB, run by the gNB, and/or run by a UE. If run by the UE, then the gNB may configure the algorithm used at the UE.

The beam sets (e.g., beam set 1 and beam set 2) can be the same, overlapping, or totally different. The beam predictor may measure (a subset of) SSBs to predict all SSBs in future and/or measure SSBs to predict some refined CSI-RS beams for unicast PDSCH/PDCCH. In some cases, the beam predictor may output a best beam ID at future time or other related metric at future time. One potential benefit of this type of beam prediction is that it may reduce RS overhead, as there is no need to send RS to track beam/channel as frequently as other beam management approaches. Another potential benefit is that uplink (UL) feedback may be reduced, as the UE may not need to feedback channel estimation as frequently. Another potential benefit is that UE power may be saved, as the UE may not need to measure and feedback information as frequently.

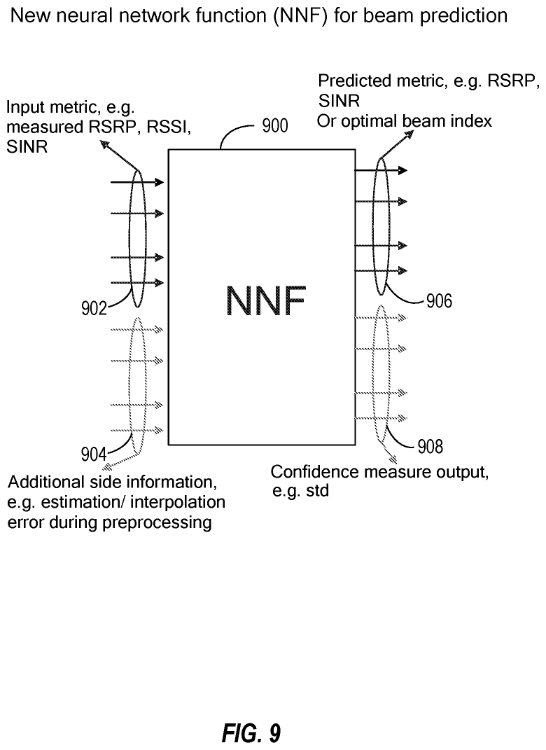

FIG. 9 shows an example of the inputs (X) and output (Y) for a NN Function 900. As illustrated, the inputs may include input metrics 902 and, optionally, side information 904. The input metrics may include, for example, RSRP, received signal strength indicator (RSSI), and/or signal to interference and noise ratio (SINR). The side information may include, for example, a time stamp, indication for whether the corresponding RSRP input is measured or not, error in the corresponding RSRP input, or expected error due to interpolation or measurement.

The outputs may include predicted metrics 906 (e.g., RSRP, SINR, or an optimal beam index) and, optionally, confidence measure output (e.g., a standard deviation, variance, confidential range given a predefined confidential level, or failure probability). Each input/output port may be associated with an SSB/CSI RS resource (set) or a transmission configuration indicator (TCI) state. For example, an output may correspond to RSRP and STD of SSB IDs 1-10.

As noted above, a prediction module (e.g., for CSI and/or beam prediction) may be deployed at the network side or the UE.

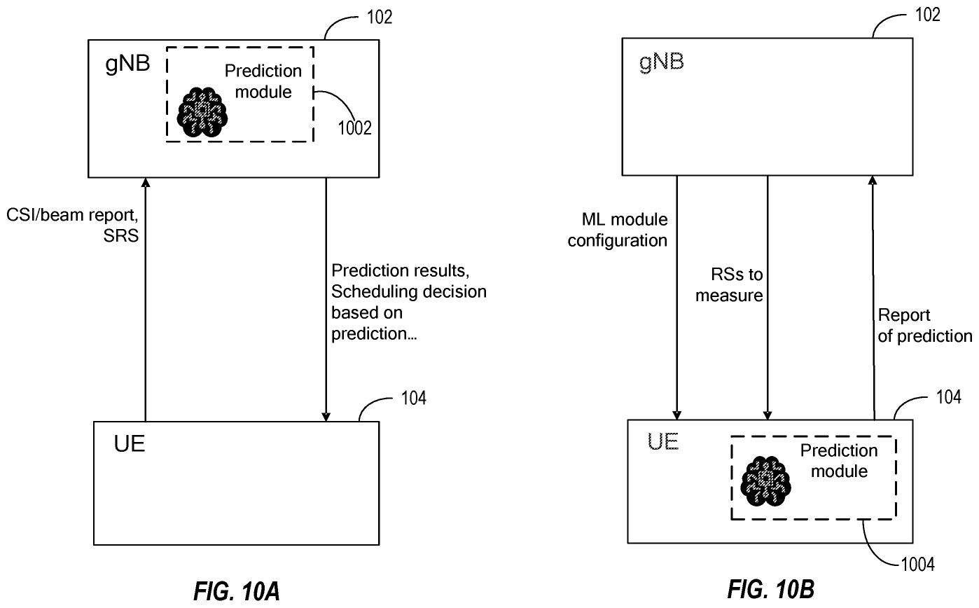

FIG. 10A illustrates a first scenario where an ML module 1002 is run at a gNB 104. In this case, the UE 102 may feedback CSI/beam report and, optionally, sounding reference signals (SRS). The gNB run ML module is based on this UE feedback and may be used in scenarios where a UE power or computation power is limited. The gNB may provide prediction results and/or make scheduling decision based on prediction results.

FIG. 10B illustrates a second scenario where an ML module 1004 is run at the UE 102. The ML module run at the UE may be configured by the gNB. The UE run ML prediction may be based on local measurement (plus gNB signaling). The UE may report the prediction results based on configuration/triggering conditions. One potential advantage of a UE run ML module is that the UE side may have more measurement results and side information than gNB side and there may be less overhead for reporting than in the gNB run ML model scenario shown in FIG. 10A.

Aspects Related to Coordinating Channel State Information (CSI) Prediction with a Beam Update

As noted above, CSI prediction generally focuses on predicting channel state information for a future time, given a fixed beamformed direction (beam, or corresponding TCI state). One potential issue with CSI prediction arises when the UE needs to switch beams (e.g., from a first beam associated with a first TCI state to a second beam associated with a second TCI state. The potential issue arises because CSI prediction only applies to a previous beam, such that the CSI prediction may not be applicable after the beam switch.

Aspects of the present disclosure may help address this potential issue by coordinating CSI prediction with a beam update. The techniques may effectively enable a design to jointly perform beam prediction and CSI prediction.

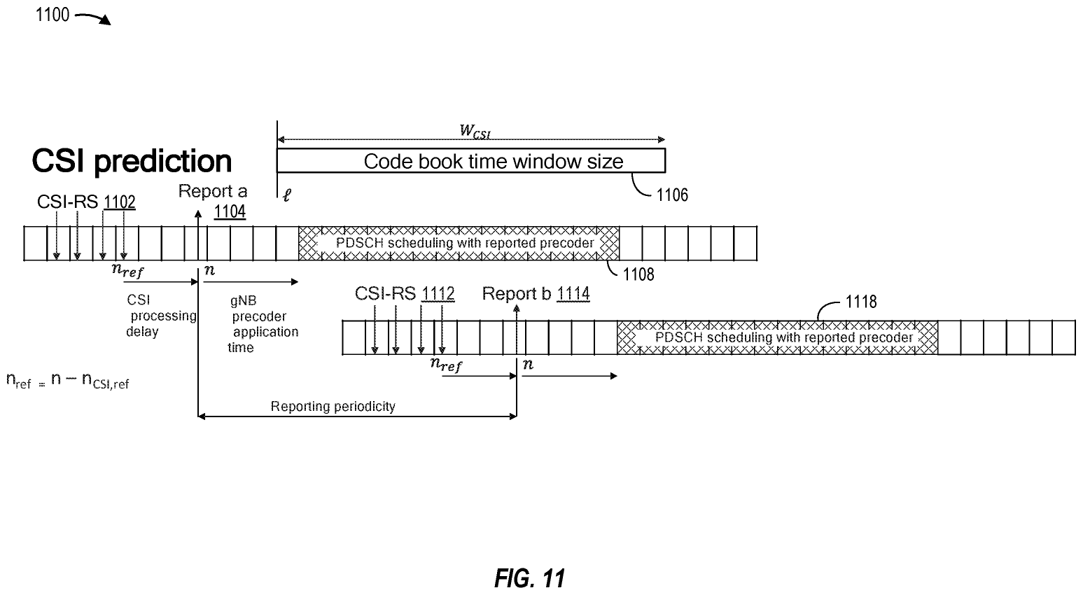

FIG. 11 illustrates an example timeline 1100 for CSI prediction, performed at the UE side (e.g., per the UE-run ML model scenario shown in FIG. 10B). In some cases, based on CSI-RS 1102, the UE may predict channel conditions (CSI) after a slot (labeled n_ref) with a CSI reference resource slot. In some cases, the UE may report (at 1104) the CSI prediction (e.g., indicating a precoder) at slot n, that occurs a CSI processing delay after the reference resource slot n_ref. A reporting window length may be configured relative to CSI-RS occasion/report periodicity.

The channel prediction may be valid within a code book time window size 1106 W_{CSI}. As shown, the network may schedule a downlink transmission (e.g., PDSCH 1108) with the reported precoder, accounting for a gNB precoder application time. As illustrated, a new report 1114, based on CSI-RS 1112, may be sent based on the report periodicity. A PDSCH 1118 may be scheduled with a reported precoder indicated in the new report 1114.

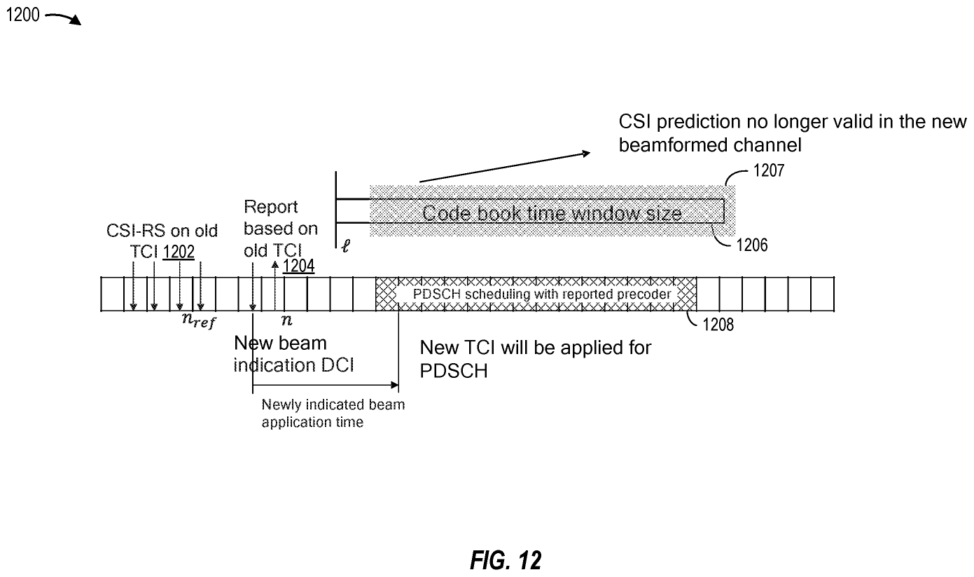

As illustrated in FIG. 12, if a beam switch occurs after a predicted CSI report, the CSI prediction may no longer be valid in the new beamformed channel. In the illustrated example, a predicted CSI report 1204 is sent based on CSI-RS 1202 associated with a first beam (old TCI). As illustrated, a new beam indication (via DCI) is sent, indicating a new beam (new TCI). As the new beam (TCI) will be applied for PDSCH after the new beam application time (indicated in the DCI), the CSI predication from report 1204 is no longer valid.

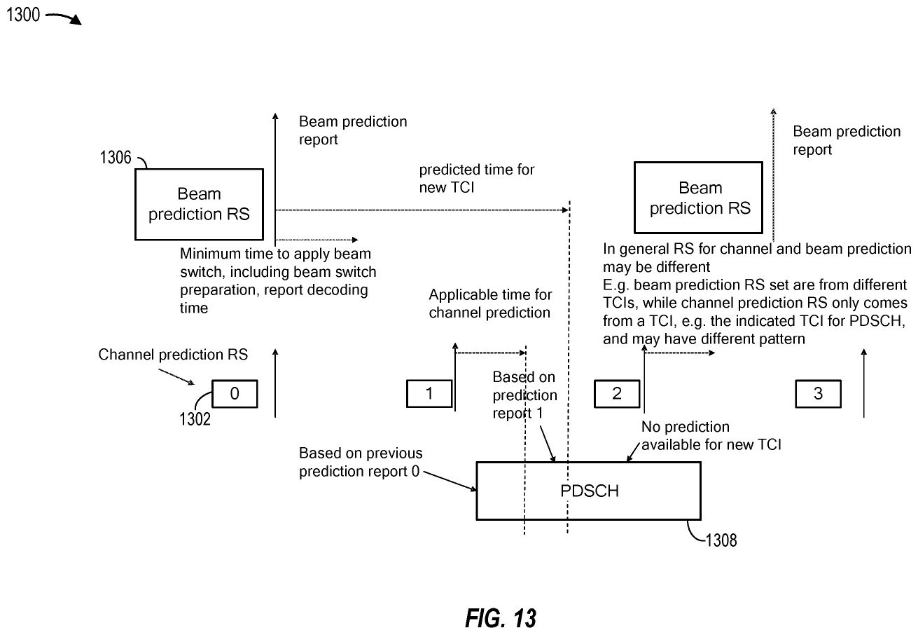

The impact of a beam switch on channel prediction, if not coordinated, is illustrated in FIG. 13. As illustrated, the UE sends a first channel prediction report (report 0), based on channel prediction RS 0 1302 (e.g., CSI-RS) sent from an old TCI. The UE also sends a beam prediction report indicating a new beam, based on beam prediction RS 1306. The UE may also send a second channel prediction report (report 1), based on channel prediction RS 1 sent from the old TCI.

As noted above, the RS for channel prediction may be different than the RS for beam prediction. For example, the beam prediction RS resource set may be from different TCIs, while channel prediction RS may be from a single TCI (e.g., the indicated TCI for PDSCH), and may have a different pattern.

As illustrated, PDSCH transmission(s) prior to the predicted application time for the new beam (TCI) may be based on (the precoders reported in) report 0 and report 1 (after the applicable time for channel prediction report 1). Unfortunately, as indicated, there is no channel prediction available for the new TCI, therefore, the precoder for PDSCH transmission(s) after the beam switch may be less than optimal.

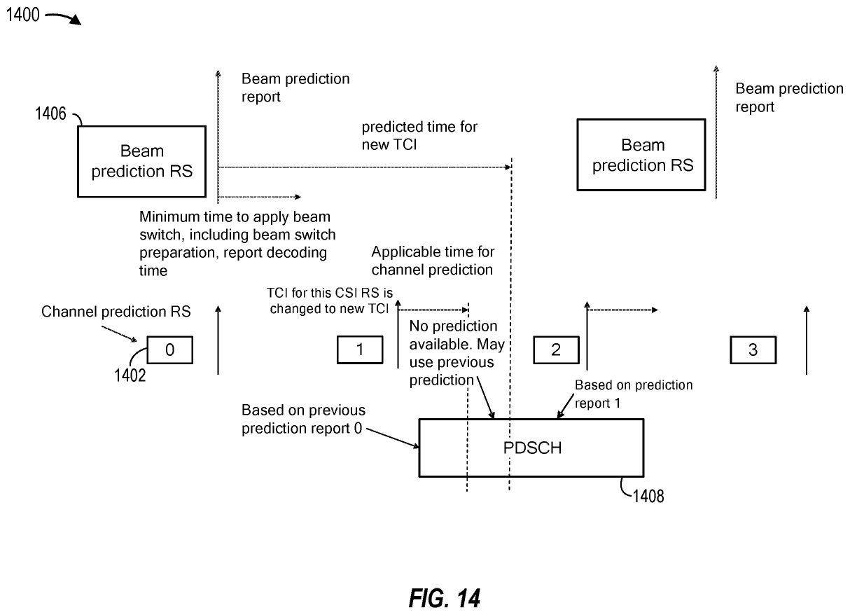

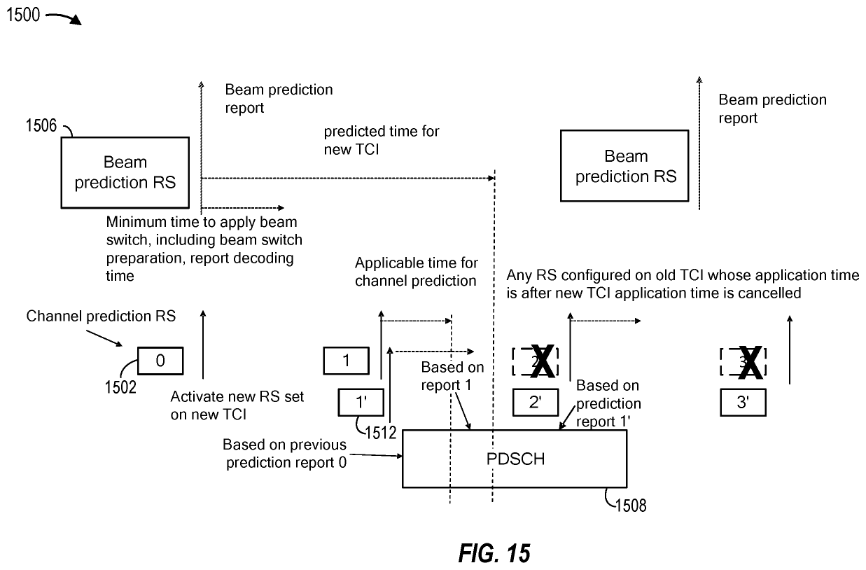

Aspects of the present disclosure, however, may allow channel prediction RS to be sent with a new beam (TCI), before the predicted application time for the new beam, which may allow channel prediction for the new TCI sooner. Coordinating channel prediction and beam updates in this manner may be understood with reference to the example timelines shown in FIG. 14 and FIG. 15.

Referring first to FIG. 14, channel prediction for a new TCI may be enabled by (autonomously) changing the TCI for the channel prediction RS. As illustrated, the UE sends a first channel prediction report (report 0), based on channel prediction RS 0 1402 sent from an old TCI. The UE also sends a beam prediction report indicating a new beam, based on beam prediction RS 1406.

In this example, however, the TCI for the second channel prediction RS 1 is changed to the new TCI. As a result, PDSCH transmission after the predicted application for the new TCI may be based on a precoder indicated in channel prediction report 1. Thus, the precoder for PDSCH transmission(s) after the beam switch may be more optimal than the example shown in FIG. 13. As illustrated, there may be no valid prediction available for the period between PDSCH transmission(s) based on the first channel prediction report 0 and the second channel prediction report 1 (based on the new TCI). Therefore, PDSCH transmission(s) in this period may be based on the previous report (e.g., channel prediction report 0).

FIG. 15 illustrates an approach that may provide a valid channel prediction for this period of time by (autonomously) activating/de-activating channel RS sets. As illustrated, the UE sends a first channel prediction report (report 0), based on channel prediction RS 0 1502 sent from an old TCI. The UE also sends a beam prediction report indicating a new beam, based on beam prediction RS 1506.

In this example, however, the TCI for the second channel prediction RS 1 may still be sent from the old TCI, while a new RS set may be activated on the new TCI. Thus, the UE may send a second channel prediction report 1 based on the old TCI and also send a third channel prediction report 1′ based on channel prediction RS 1′ 1512 sent on the new TCI.

As a result, channel prediction report 1 (based on the old TCI) provides a valid prediction available for the period between PDSCH transmission(s) based on the first channel prediction report 0 and the second channel prediction report 1′ (based on the new TCI). Therefore, a precoder for PDSCH transmission(s) in this period may be more optimal than the approach shown in FIG. 14 (e.g., when a previous prediction was used for this period.

As illustrated in FIG. 15, any RS configured on the old TCI, whose application time is after the new TCI application time, may be cancelled. While the approach shown in FIG. 15 may consume more RS resources than the approach shown in FIG. 14, this approach allows a more current channel prediction, based on the old TCI (for use before the predicted application time of the new TCI.

While examples have been described herein with reference to downlink (e.g., PDSCH transmissions) from a network entity (e.g., a gNB) to a UE, similar techniques may be applied to optimize predicted precoder selection for other types of transmission (e.g., sidelink transmissions between UEs), in conjunction with the occurrence of beam updates. Further, the techniques may be utilized for transmissions involving intermediate entities (e.g., relays).

### Example Operations

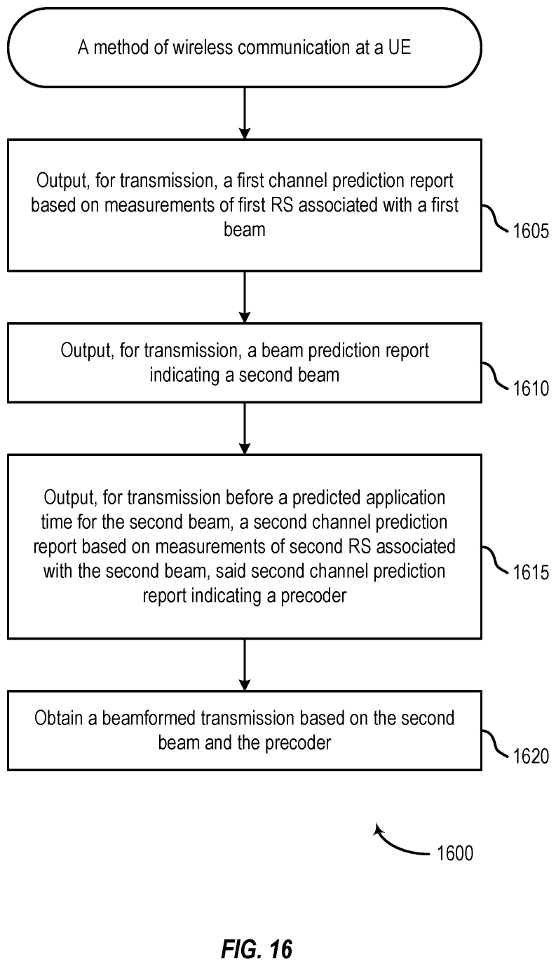

FIG. 16 shows an example of a method 1600 of wireless communication at a UE, such as a UE 104 of FIGS. 1 and 3.

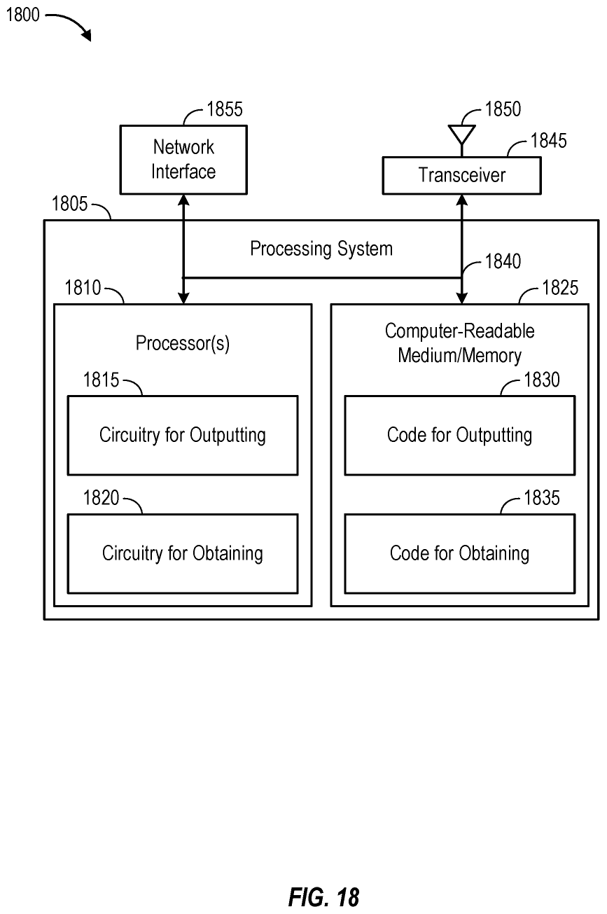

Method 1600 begins at step 1605 with outputting, for transmission, a first channel prediction report based on measurements of first RS associated with a first beam. In some cases, the operations of this step refer to, or may be performed by, circuitry for outputting and/or code for outputting as described with reference to FIG. 18.

Method 1600 then proceeds to step 1610 with outputting, for transmission, a beam prediction report indicating a second beam. In some cases, the operations of this step refer to, or may be performed by, circuitry for outputting and/or code for outputting as described with reference to FIG. 18.

Method 1600 then proceeds to step 1615 with outputting, for transmission before a predicted application time for the second beam, a second channel prediction report based on measurements of second RS associated with the second beam, said second channel prediction report indicating a precoder. In some cases, the operations of this step refer to, or may be performed by, circuitry for outputting and/or code for outputting as described with reference to FIG. 18.

Method 1600 then proceeds to step 1620 with obtaining a beamformed transmission based on the second beam and the precoder. In some cases, the operations of this step refer to, or may be performed by, circuitry for obtaining and/or code for obtaining as described with reference to FIG. 18.

In some aspects, the beamformed transmission comprises a PDSCH.

In some aspects, the method 1600 further includes obtaining control information that at least one of: indicates a switch to the second beam; or schedules the beamformed transmission with the precoder. In some cases, the operations of this step refer to, or may be performed by, circuitry for obtaining and/or code for obtaining as described with reference to FIG. 18.

In some aspects, the first RS are obtained via an RS resource set with a first TCI state corresponding to the first beam; and the second RS are obtained on the same RS resource set with a second TCI state corresponding to the second beam.

In some aspects, the method 1600 further includes obtaining, after outputting the second channel prediction report, at least one beamformed transmission based on the first beam and a precoder indicated in the first channel prediction report. In some cases, the operations of this step refer to, or may be performed by, circuitry for obtaining and/or code for obtaining as described with reference to FIG. 18.

In some aspects, the first RS are obtained on a first RS resource set with a first TCI state corresponding to the first beam; and the second RS are obtained on a second RS resource set, with a second TCI state corresponding to the second beam.

In some aspects, the first and second RS resource sets are both activated for some time prior to the predicted application time for the second beam; and the first RS resource set is canceled after the predicted application time for the second beam.

In some aspects, the method 1600 further includes outputting, for transmission before the predicted application time for the second beam, a third channel prediction report based on measurements of third channel prediction RS obtained on the first RS resource set with the first TCI state. In some cases, the operations of this step refer to, or may be performed by, circuitry for outputting and/or code for outputting as described with reference to FIG. 18.

In some aspects, the method 1600 further includes obtaining, after outputting the second channel prediction report, at least one beamformed transmission based on the first beam and a precoder indicated in the third channel prediction report. In some cases, the operations of this step refer to, or may be performed by, circuitry for obtaining and/or code for obtaining as described with reference to FIG. 18.

In some aspects, the method 1600 further includes obtaining, after outputting the second channel prediction report, at least one beamformed transmission based on the first beam and a precoder indicated in the first channel prediction report. In some cases, the operations of this step refer to, or may be performed by, circuitry for obtaining and/or code for obtaining as described with reference to FIG. 18.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

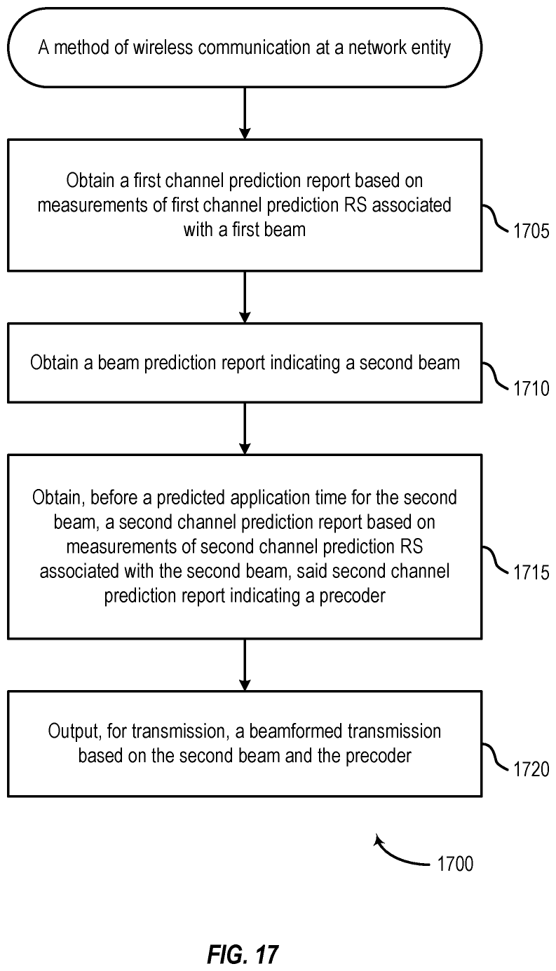

FIG. 17 shows an example of a method 1700 of wireless communication at a network entity, such as a BS 102 of FIGS. 1 and 3, or a disaggregated base station as discussed with respect to FIG. 2.

Method 1700 begins at step 1705 with obtaining a first channel prediction report based on measurements of first channel prediction RS associated with a first beam. In some cases, the operations of this step refer to, or may be performed by, circuitry for obtaining and/or code for obtaining as described with reference to FIG. 18.

Method 1700 then proceeds to step 1710 with obtaining a beam prediction report indicating a second beam. In some cases, the operations of this step refer to, or may be performed by, circuitry for obtaining and/or code for obtaining as described with reference to FIG. 18.

Method 1700 then proceeds to step 1715 with obtaining, before a predicted application time for the second beam, a second channel prediction report based on measurements of second channel prediction RS associated with the second beam, said second channel prediction report indicating a precoder. In some cases, the operations of this step refer to, or may be performed by, circuitry for obtaining and/or code for obtaining as described with reference to FIG. 18.

Method 1700 then proceeds to step 1720 with outputting, for transmission, a beamformed transmission based on the second beam and the precoder. In some cases, the operations of this step refer to, or may be performed by, circuitry for outputting and/or code for outputting as described with reference to FIG. 18.

In some aspects, the beamformed transmission comprises a PDSCH.

In some aspects, the method 1700 further includes outputting, for transmission, control information that at least one of: indicates a switch to the second beam; or schedules the beamformed transmission with the precoder. In some cases, the operations of this step refer to, or may be performed by, circuitry for outputting and/or code for outputting as described with reference to FIG. 18.

In some aspects, the method 1700 further includes outputting, for transmission, the first RS via an RS resource set with a first TCI state corresponding to the first beam. In some cases, the operations of this step refer to, or may be performed by, circuitry for outputting and/or code for outputting as described with reference to FIG. 18.

In some aspects, the method 1700 further includes outputting, for transmission, the second RS on the same RS resource set with a second TCI state corresponding to the second beam. In some cases, the operations of this step refer to, or may be performed by, circuitry for outputting and/or code for outputting as described with reference to FIG. 18.

In some aspects, the method 1700 further includes outputting, after obtaining the second channel prediction report, at least one beamformed transmission based on the first beam and a precoder indicated in the first channel prediction report. In some cases, the operations of this step refer to, or may be performed by, circuitry for outputting and/or code for outputting as described with reference to FIG. 18.

In some aspects, the method 1700 further includes outputting, for transmission, the first RS on a first RS resource set with a first TCI state corresponding to the first beam. In some cases, the operations of this step refer to, or may be performed by, circuitry for outputting and/or code for outputting as described with reference to FIG. 18.

In some aspects, the method 1700 further includes outputting, for transmission, the second RS on a second RS resource set, with a second TCI state corresponding to the second beam. In some cases, the operations of this step refer to, or may be performed by, circuitry for outputting and/or code for outputting as described with reference to FIG. 18.

In some aspects, the first and second RS resource sets are both activated for some time prior to the predicted application time for the second beam; and the first RS resource set is canceled after the predicted application time for the second beam.

In some aspects, the method 1700 further includes obtaining, before the predicted application time for the second beam, a third channel prediction report based on measurements of third channel prediction RS output for transmission on the first RS resource set with the first TCI state. In some cases, the operations of this step refer to, or may be performed by, circuitry for obtaining and/or code for obtaining as described with reference to FIG. 18.

In some aspects, the method 1700 further includes outputting, for transmission after obtaining the second channel prediction report, at least one beamformed transmission based on the first beam and a precoder indicated in the third channel prediction report. In some cases, the operations of this step refer to, or may be performed by, circuitry for outputting and/or code for outputting as described with reference to FIG. 18.

In some aspects, the method 1700 further includes outputting, after obtaining the second channel prediction report, at least one beamformed transmission based on the first beam and a precoder indicated in the first channel prediction report. In some cases, the operations of this step refer to, or may be performed by, circuitry for outputting and/or code for outputting as described with reference to FIG. 18.

In one aspect, method 1700, or any aspect related to it, may be performed by an apparatus, such as communications device 1800 of FIG. 18, which includes various components operable, configured, or adapted to perform the method 1700. Communications device 1800 is described below in further detail.

Note that FIG. 17 is just one example of a method, and other methods including fewer, additional, or alternative steps are possible consistent with this disclosure.

### Example Communications Device

FIG. 18 depicts aspects of an example communications device 1800. In some aspects, communications device 1800 is a user equipment, such as UE 104 described above with respect to FIGS. 1 and 3. In some aspects, communications device 1800 is a network entity, such as BS 102 of FIGS. 1 and 3, or a disaggregated base station as discussed with respect to FIG. 2.

The communications device 1800 includes a processing system 1805 coupled to the transceiver 1845 (e.g., a transmitter and/or a receiver). In some aspects (e.g., when communications device 1800 is a network entity), processing system 1805 may be coupled to a network interface 1855 that is configured to obtain and send signals for the communications device 1800 via communication link(s), such as a backhaul link, midhaul link, and/or fronthaul link as described herein, such as with respect to FIG. 2. The transceiver 1845 is configured to transmit and receive signals for the communications device 1800 via the antenna 1850, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1825 via a bus 1840. In certain aspects, the computer-readable medium/memory 1825 is configured to store instructions (e.g., computer-executable code) that when executed by the one or more processors 1810, cause the one or more processors 1810 to perform the method 1600 described with respect to FIG. 16, or any aspect related to it; and the method 1700 described with respect to FIG. 17, or any aspect related to it. Note that reference to a processor performing a function of communications device 1800 may include one or more processors 1810 performing that function of communications device 1800.

In the depicted example, computer-readable medium/memory 1825 stores code (e.g., executable instructions), such as code for outputting 1830 and code for obtaining 1835. Processing of the code for outputting 1830 and code for obtaining 1835 may cause the communications device 1800 to perform the method 1600 described with respect to FIG. 16, or any aspect related to it; and the method 1700 described with respect to FIG. 17, or any aspect related to it.

The one or more processors 1810 include circuitry configured to implement (e.g., execute) the code stored in the computer-readable medium/memory 1825, including circuitry for outputting 1815 and circuitry for obtaining 1820. Processing with circuitry for outputting 1815 and circuitry for obtaining 1820 may cause the communications device 1800 to perform the method 1600 described with respect to FIG. 16, or any aspect related to it; and the method 1700 described with respect to FIG. 17, or any aspect related to it.

Various components of the communications device 1800 may provide means for performing the method 1600 described with respect to FIG. 16, or any aspect related to it; and the method 1700 described with respect to FIG. 17, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1845 and the antenna 1850 of the communications device 1800 in FIG. 18. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1845 and the antenna 1850 of the communications device 1800 in FIG. 18.

### Example Clauses

Implementation examples are described in the following numbered clauses:

Clause 1: A method of wireless communication at a UE, comprising: outputting, for transmission, a first channel prediction report based on measurements of first RS associated with a first beam; outputting, for transmission, a beam prediction report indicating a second beam; outputting, for transmission before a predicted application time for the second beam, a second channel prediction report based on measurements of second RS associated with the second beam, said second channel prediction report indicating a precoder; and obtaining a beamformed transmission based on the second beam and the precoder.

Clause 2: The method of Clause 1, wherein the beamformed transmission comprises a PDSCH.

Clause 3: The method of any one of Clauses 1 and 2, further comprising obtaining control information that at least one of: indicates a switch to the second beam; or schedules the beamformed transmission with the precoder.

Clause 4: The method of any one of Clauses 1-3, wherein: the first RS are obtained via an RS resource set with a first TCI state corresponding to the first beam; and the second RS are obtained on the same RS resource set with a second TCI state corresponding to the second beam.

Clause 5: The method of Clause 4, further comprising: obtaining, after outputting the second channel prediction report, at least one beamformed transmission based on the first beam and a precoder indicated in the first channel prediction report.

Clause 6: The method of any one of Clauses 1-5, wherein: the first RS are obtained on a first RS resource set with a first TCI state corresponding to the first beam; and the second RS are obtained on a second RS resource set, with a second TCI state corresponding to the second beam.

Clause 7: The method of Clause 6, wherein the first and second RS resource sets are both activated for some time prior to the predicted application time for the second beam; and the first RS resource set is canceled after the predicted application time for the second beam.

Clause 8: The method of Clause 6, further comprising: outputting, for transmission before the predicted application time for the second beam, a third channel prediction report based on measurements of third channel prediction RS obtained on the first RS resource set with the first TCI state; and obtaining, after outputting the second channel prediction report, at least one beamformed transmission based on the first beam and a precoder indicated in the third channel prediction report.

Clause 9: The method of Clause 8, further comprising: obtaining, after outputting the second channel prediction report, at least one beamformed transmission based on the first beam and a precoder indicated in the first channel prediction report.

Clause 10: A method of wireless communication at a network entity, comprising: obtaining a first channel prediction report based on measurements of first channel prediction RS associated with a first beam; obtaining a beam prediction report indicating a second beam; obtaining, before a predicted application time for the second beam, a second channel prediction report based on measurements of second channel prediction RS associated with the second beam, said second channel prediction report indicating a precoder; and outputting, for transmission, a beamformed transmission based on the second beam and the precoder.

Clause 11: The method of Clause 10, wherein the beamformed transmission comprises a PDSCH.

Clause 12: The method of any one of Clauses 10 and 11, further comprising outputting, for transmission, control information that at least one of: indicates a switch to the second beam; or schedules the beamformed transmission with the precoder.

Clause 13: The method of any one of Clauses 10-12, further comprising: outputting, for transmission, the first RS via an RS resource set with a first TCI state corresponding to the first beam; and outputting, for transmission, the second RS on the same RS resource set with a second TCI state corresponding to the second beam.

Clause 14: The method of Clause 13, further comprising: outputting, after obtaining the second channel prediction report, at least one beamformed transmission based on the first beam and a precoder indicated in the first channel prediction report.

Clause 15: The method of any one of Clauses 10-14, further comprising: outputting, for transmission, the first RS on a first RS resource set with a first TCI state corresponding to the first beam; and outputting, for transmission, the second RS on a second RS resource set, with a second TCI state corresponding to the second beam.

Clause 16: The method of Clause 15, wherein the first and second RS resource sets are both activated for some time prior to the predicted application time for the second beam; and the first RS resource set is canceled after the predicted application time for the second beam.

Clause 17: The method of Clause 15, further comprising: obtaining, before the predicted application time for the second beam, a third channel prediction report based on measurements of third channel prediction RS output for transmission on the first RS resource set with the first TCI state; and outputting, for transmission after obtaining the second channel prediction report, at least one beamformed transmission based on the first beam and a precoder indicated in the third channel prediction report.

Clause 18: The method of Clause 17, further comprising: outputting, after obtaining the second channel prediction report, at least one beamformed transmission based on the first beam and a precoder indicated in the first channel prediction report.

Clause 19: An apparatus, comprising: a memory comprising executable instructions; and a processor configured to execute the executable instructions and cause the apparatus to perform a method in accordance with any one of Clauses 1-18.

Clause 20: An apparatus, comprising means for performing a method in accordance with any one of Clauses 1-18.

Clause 21: A non-transitory computer-readable medium comprising executable instructions that, when executed by a processor of an apparatus, cause the apparatus to perform a method in accordance with any one of Clauses 1-18.

Clause 22: A computer program product embodied on a computer-readable storage medium comprising code for performing a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising: a memory comprising instructions; and one or more processors configured to execute the instructions and cause the apparatus to:
output, for transmission, a first channel prediction report based on measurements by a user equipment (UE) of first reference signals (RS) associated with a first beam;
output, for transmission, a beam prediction report indicating a second beam;
output, for transmission before a predicted application time for the second beam, a second channel prediction report based on measurements of second RS associated with the second beam, said second channel prediction report indicating a precoder; and
obtain a beamformed transmission based on the second beam and the precoder.

2. The apparatus of claim 1, wherein the beamformed transmission comprises a physical downlink shared channel (PDSCH).

3. The apparatus of claim 1, wherein the one or more processors are further configured to execute the instructions and cause the apparatus to obtain control information that at least one of:
indicates a switch to the second beam; or
schedules the beamformed transmission with the precoder.

4. The apparatus of claim 1, wherein:
the first RS are obtained via an RS resource set with a first transmission configuration indicator (TCI) state corresponding to the first beam; and
the second RS are obtained on the same RS resource set with a second TCI state corresponding to the second beam.

5. The apparatus of claim 4, wherein the one or more processors are further configured to execute the instructions and cause the apparatus to:
obtain, after outputting the second channel prediction report, at least one beamformed transmission based on the first beam and a precoder indicated in the first channel prediction report.

6. The apparatus of claim 1, wherein:
the first RS are obtained on a first RS resource set with a first transmission configuration indicator (TCI) state corresponding to the first beam; and
the second RS are obtained on a second RS resource set, with a second TCI state corresponding to the second beam.

7. The apparatus of claim 6, wherein
the first and second RS resource sets are both activated for some time prior to the predicted application time for the second beam; and
the first RS resource set is canceled after the predicted application time for the second beam.

8. The apparatus of claim 6, wherein the one or more processors are further configured to execute the instructions and cause the apparatus to:
output, for transmission before the predicted application time for the second beam, a third channel prediction report based on measurements of third channel prediction RS obtained on the first RS resource set with the first TCI state; and
obtain, after outputting the second channel prediction report, at least one beamformed transmission based on the first beam and a precoder indicated in the third channel prediction report.

9. The apparatus of claim 8, wherein the one or more processors are further configured to execute the instructions and cause the apparatus to:
obtain, after outputting the second channel prediction report, at least one beamformed transmission based on the first beam and a precoder indicated in the first channel prediction report.

10. An apparatus for wireless communications, comprising: a memory comprising instructions; and one or more processors configured to execute the instructions and cause the apparatus to:
obtain a first channel prediction report based on measurements of first channel prediction reference signals (RS) associated with a first beam;
obtain a beam prediction report indicating a second beam;
obtain, before a predicted application time for the second beam, a second channel prediction report based on measurements of second channel prediction reference signals (RS) associated with the second beam, said second channel prediction report indicating a precoder; and
output, for transmission, a beamformed transmission based on the second beam and the precoder.

11. The apparatus of claim 10, wherein the beamformed transmission comprises a physical downlink shared channel (PDSCH).

12. The apparatus of claim 10, wherein the one or more processors are further configured to execute the instructions and cause the apparatus to output, for transmission, control information that at least one of:
indicates a switch to the second beam; or
schedules the beamformed transmission with the precoder.

13. The apparatus of claim 10, wherein the one or more processors are further configured to execute the instructions and cause the apparatus to:
output, for transmission, the first RS via an RS resource set with a first transmission configuration indicator (TCI) state corresponding to the first beam; and
output, for transmission, the second RS on the same RS resource set with a second TCI state corresponding to the second beam.

14. The apparatus of claim 13, wherein the one or more processors are further configured to execute the instructions and cause the apparatus to:
output, after obtaining the second channel prediction report, at least one beamformed transmission based on the first beam and a precoder indicated in the first channel prediction report.

15. The apparatus of claim 10, wherein:
outputting, for transmission, the first RS on a first RS resource set with a first transmission configuration indicator (TCI) state corresponding to the first beam; and
outputting, for transmission, the second RS on a second RS resource set, with a second TCI state corresponding to the second beam.

16. The apparatus of claim 15, wherein:
the first and second RS resource sets are both activated for some time prior to the predicted application time for the second beam; and
the first RS resource set is canceled after the predicted application time for the second beam.

17. The apparatus of claim 15, wherein the one or more processors are further configured to execute the instructions and cause the apparatus to:
obtain, before the predicted application time for the second beam, a third channel prediction report based on measurements of third channel prediction RS output for transmission on the first RS resource set with the first TCI state; and
output, for transmission after obtaining the second channel prediction report, at least one beamformed transmission based on the first beam and a precoder indicated in the third channel prediction report.

18. The apparatus of claim 17, wherein the one or more processors are further configured to execute the instructions and cause the apparatus to:
output, after obtaining the second channel prediction report, at least one beamformed transmission based on the first beam and a precoder indicated in the first channel prediction report.

19. The apparatus of claim 10, further comprising at least one transceiver, wherein:
the at least one transceiver is configured to receive the first channel prediction report, receive the beam prediction report, receive the second channel prediction report, and transmit the beamformed transmission; and
the apparatus is configured as a network entity.

20. A user equipment (UE), comprising: at least one transceiver; a memory comprising instructions; and one or more processors configured to execute the instructions and cause the UE to:
transmit a first channel prediction report based on measurements by a user equipment (UE) of first reference signals (RS) associated with a first beam;
output, for transmission, a beam prediction report indicating a second beam;
transmit, before a predicted application time for the second beam, a second channel prediction report based on measurements of second RS associated with the second beam, said second channel prediction report indicating a precoder; and
receive a beamformed transmission based on the second beam and the precoder.
